(19) United States
(12) Patent Application Publication
(10) Pub. No.: US 2016/0071550 A1
(43) Pub. Date: Mar. 10, 2016

(54) VIDEO SYSTEM FOR EMBEDDING EXCITEMENT DATA AND METHODS FOR USE THEREWITH

(71) Applicant: ViXS Systems, Inc., Toronto (CA)

(72) Inventor: Sally Jean Daub, Toronto (CA)

(73) Assignee: ViXS Systems, Inc., Toronto (CA)

(21) Appl. No.: 14/477,064

(22) Filed: Sep. 4, 2014

(51) Int. Cl. G11B 27/30; G11B 27/11; G11B 27/34; H04N 5/77; H04N 5/232

(52) U.S. Cl. CPC G11B 27/3036; H04N 5/772; H04N 5/23219; G11B 27/34; G11B 27/11

(57) ABSTRACT

A video system includes a video capture device that operates under control of a user to generate a video signal having video content. A biometric signal generator generates excitement data in response to excitement of the user. A metadata association device generates a processed video signal from the video signal that includes time-coded metadata, wherein the time-coded metadata includes the excitement data. A video storage device stores the processed video signal.

### CROSS REFERENCE TO RELATED PATENTS

None

### TECHNICAL FIELD OF THE INVENTION

The present invention relates to the processing of video signals.

### DESCRIPTION OF RELATED ART

Video recorders used to be expensive stand-alone devices. Now, video recording capabilities are built into digital cameras, smart phones, laptops, tablets and other devices. Consumer electronic devices are evolving rapidly to the point where the dividing lines start to blur among different classes of devices. Continuing integration may proceed along multitude of pathways.

With the proliferation of such sources of video content, users are faced with an ever expanding amount of video that is generated. However, the problems of indexing and searching video programming have remained. Further limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIG. 1 presents a block diagram representation of a video system in accordance with an embodiment of the present invention.

FIG. 2 presents a block diagram representation of a biometric signal generator 125 in accordance with an embodiment of the present invention.

FIG. 3 presents a graphical diagram representation of excitement data in accordance with an embodiment of the present invention.

FIGS. 4 and 5 present pictorial diagram representations of components of a video system in accordance with embodiments of the present invention.

FIGS. 6-8 present pictorial diagram representations of video systems in accordance with embodiments of the present invention.

FIG. 9 presents a block diagram representation of a metadata processing device in accordance with an embodiment of the present invention.

FIG. 10 presents a pictorial process flow representation in accordance with an embodiment of the present invention.

FIG. 11 presents a pictorial diagram representation of a video processing device in accordance with an embodiment of the present invention.

FIG. 12 presents a flow diagram representation of a method in accordance with an embodiment of the present invention.

FIG. 13 presents a flow diagram representation of a method in accordance with an embodiment of the present invention.

### DETAILED DESCRIPTION OF THE INVENTION INCLUDING THE PRESENTLY PREFERRED EMBODIMENTS

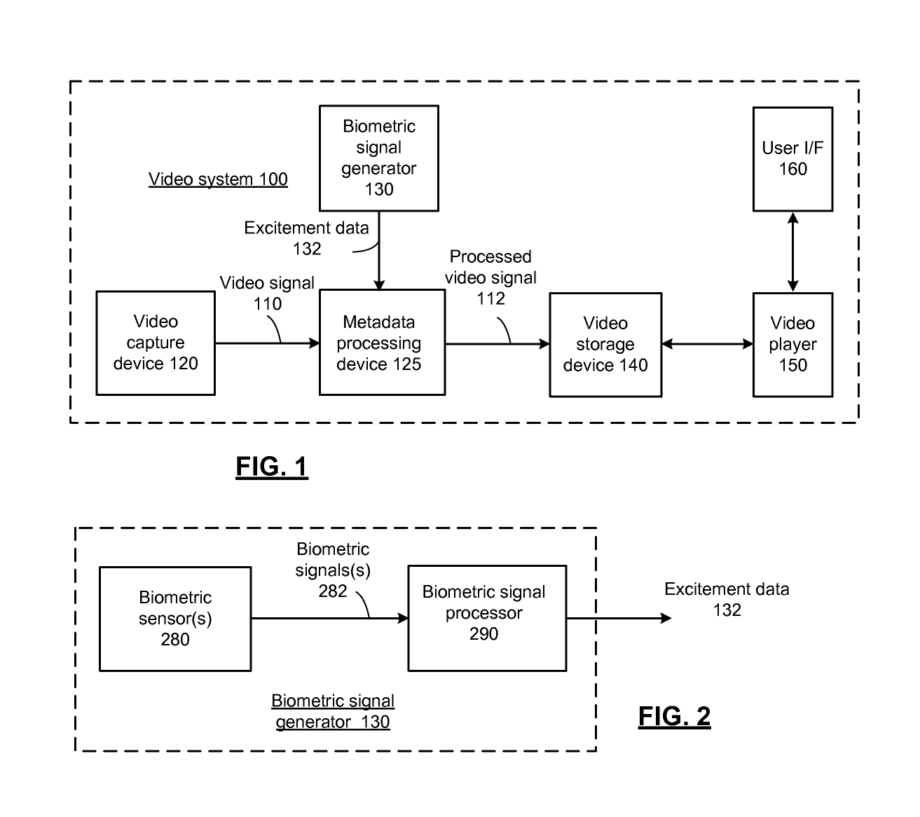

FIG. 1 presents a block diagram representation of a video system in accordance with an embodiment of the present invention. In particular, a video system 100 is presented that includes a video capture device 120, a biometric signal generator 130, a metadata processing device 125, a video storage device 140, a video player 150 and a user interface (I/F) 160.

In operation, the video capture device 120 operates under the control of a user to generate a video signal 110 having associated video content. The video capture device 120 can include a digital imaging device such as a charge coupled device or other imaging device, a lens, image stabilization circuitry, processing circuitry to produce video signal 110 and a user interface that allows the user to control the operation of the video capture device. Such a user interface may be included in the video capture device 120 or, while not specifically shown, can be included in user interface 160.

Video signal 110 can include a digital video signal complying with a digital video codec standard such as H.264, MPEG-4 Part 10 Advanced Video Coding (AVC) including an SVC signal, an encoded stereoscopic video signal having a base layer that includes a 2D compatible base layer and an enhancement layer generated by processing in accordance with an MVC extension of MPEG-4 AVC, or another digital format such as a H.265, another Motion Picture Experts Group (MPEG), Quicktime format, Real Media format, Windows Media Video (WMV) or Audio Video Interleave (AVI), video coding one (VC-1), VP8, or other digital video format.

The biometric signal generator 130 generates excitement data 132 in response to the excitement of the user—in particular, the user's excitement associated with the events being captured by video capture device 120. The metadata association device generates a processed video signal 112 from the video signal 110 that includes the video content from video signal 110 as well as time-coded metadata, wherein the time-coded metadata includes the excitement data 132. The processed video signal 112 is stored in the video storage device 140. The processed video signal 112 can be in the same format as the video signal 110 but be appended with the metadata, can be in a different format from video signal 110, can have the metadata embedded as a watermark or other signal in the video content itself, or be in some different format that includes the video content from video signal 110 and the time-coded metadata.

The video player 150 searches for video content in the video storage device 140 based on search data received via the user interface 160. When the search data indicates a search for content with high excitement, the video player is able to search the video content stored in video storage device 140 based on the time-coded metadata associated with each instance of processed video signal 112.

In an embodiment, the time-coded metadata indicates periods of high excitement of the user and correlates the periods of high excitement of the user to corresponding periods of time in the video signal 110 via video timestamps or other indicators of specific locations within the video signal that indicate high excitement. The excitement data 132 can be associated with the video content and can be used to search for and identify video content and/or particular portions of a recorded video corresponding to high levels of excitement of the user.

In this fashion, the video player 140 is able to identify and retrieve particular processed video signals 112 that are associated with high levels of user excitement and further to specifically locate the periods of time in the processed video signal 112 corresponding to the periods of high excitement of the user. For example, the video storage device can queue up a processed video signal 112 at one or more the periods of time corresponding to the periods of high excitement of the user. This avoids having the user having to manually hunt through different videos to locate a video of interest and/or having the user hunting through a video for particular portions associated with an exciting event or occurrence.

The video storage device 140 can include a hard disk drive or other disk drive, read-only memory, random access memory, volatile memory, non-volatile memory, static memory, dynamic memory, flash memory, cache memory, and/or any device that stores digital information. The user interface 160 can include a touch screen, a video display screen or other display device, one or more buttons, a mouse or other pointing device, a key board, a microphone, speakers and one or more other user interface devices.

The video player 150 and the metadata processing device 125 can each be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory. These memories may each be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when metadata processing device 125 and/or video player 150 implement one or more of their functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

While video system 100 is shown as an integrated system, it should be noted that the video system 100 can be implemented as a single device or as a plurality of individual components that communicate with one another wirelessly and/or via one or more wired connections. The further operation of video system 100, including illustrative examples and several optional functions and features is described in greater detail in conjunction with FIGS. 2-13.

FIG. 2 presents a block diagram representation of a biometric signal generator 125 in accordance with an embodiment of the present invention. In particular, a biometric signal generator 130 includes one or more biometric sensor(s) 280 that generate one or more biometric signal(s) 282 based on the user. A biometric signal processor 290 generates the excitement data 132 based on analysis of the one or more biometric signal(s) 282.

The biometric signal processor 290 can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory. These memories may each be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the biometric signal processor 290 implement one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

In an embodiment, the biometric sensor(s) 280 can include an optical sensor, resistive touch sensor, capacitive touch sensor or other sensor that monitors the heart rate and/or level of perspiration of the user. In these embodiments, a high level of excitement can be determined by the biometric signal processor 290 based on a sudden increase in heart rate or perspiration.

In an embodiment, the biometric sensor(s) 280 can include a microphone that captures the voice of the user and/or voices or others in the surrounding area. In these cases the voice of the user can be analyzed by the biometric signal processor 290 based on speech patterns such as pitch, cadence or other factors and/or cheers, applause or other sounds can be analyzed to detect a high level of excitement of the user or others.

In an embodiment, the biometric sensor(s) 280 can include an imaging sensor or other sensor that generates a biometric signal that indicates a dilation of an eye of the user and/or a wideness of opening of an eye of the user. In these cases, a high level of user excitement can be determined by the biometric signal processor 290 based on a sudden dilation of the user's eyes and/or based on a sudden widening of the eyes.

It should be noted that multiple biometric sensors 280 can be implemented and the biometric signal processor 290 can generate excitement data 132 based on an analysis of the biometric signals 282 from each of the biometric sensors 280. In this fashion, periods of time corresponding to high levels of excitement can be more accurately determined based on multiple different criteria.

Consider an example where a parent is videoing their baby taking his or her first steps. A sudden increase in heart rate, perspiration, eye wideness, pupil dilation, changes in voice and spontaneous cheers, may together or separately indicate that the user has suddenly become highly excited. This high level of excitement can be indicated by excitement data 132 that is used to generate time-coded metadata that is associated with the recorded video. At some later time, the video of the first steps and/or other specific portion of the video corresponding to the first steps can be founds based on a search for “high excitement”. The user can access this video footage for either editing or viewing.

In another example, a parent is videoing their daughter's soccer game. A sudden increase in heart rate, perspiration, eye wideness, pupil dilation, changes in voice and spontaneous cheers, may together or separately indicate that the user has suddenly become highly excited—for example when their daughter scores a goal. This high level of excitement can be indicated by excitement data 132 that is used to generate time-coded metadata that is associated with the recorded video.

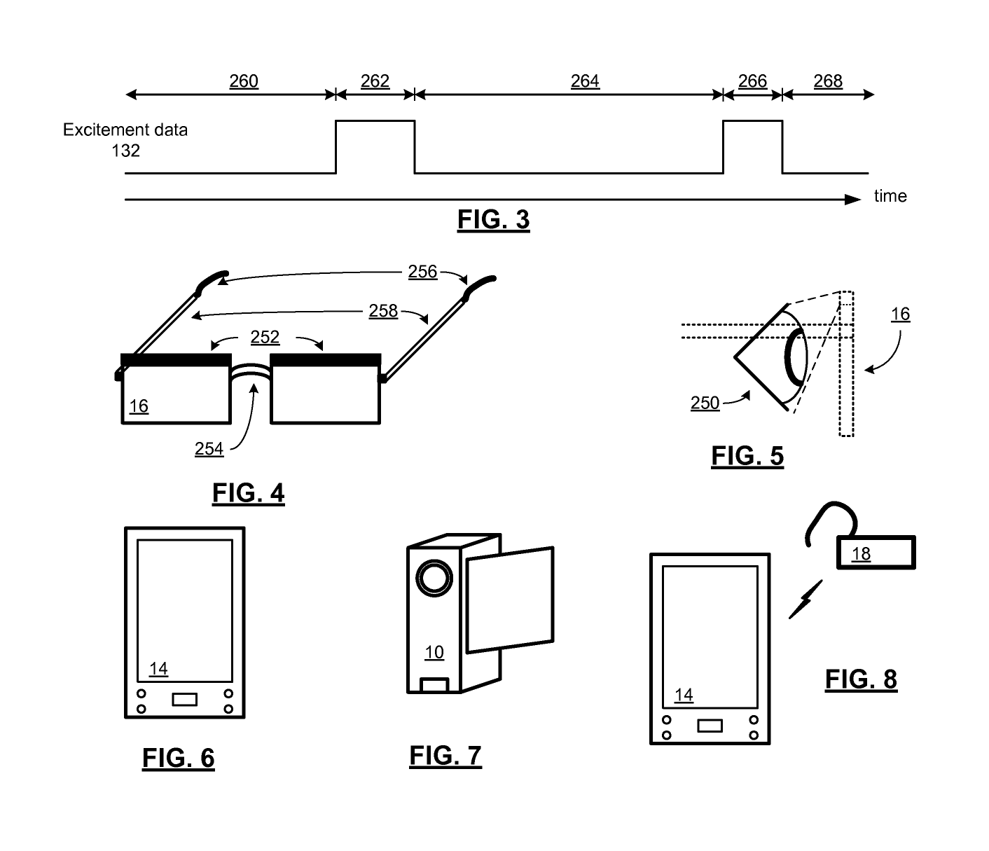

FIG. 3 presents a graphical diagram representation of excitement data in accordance with an embodiment of the present invention. In particular, a graph of excitement data 132 as a function of time is presented. In this example, an analysis of one or more biometric signals 280 indicating a sudden increase in heart rate, perspiration, eye wideness, pupil dilation, changes in voice and spontaneous cheers, are used to generate binary excitement data that indicate periods of time that the user has reached a high level of excitement. In the example shown, the excitement data 132 is presented as a binary value with a high logic state (periods 262 and 266) corresponding to high excitement and a low logic state (periods 260, 264 and 268) corresponding to a low level of excitement or otherwise a lack of high excitement.

In an embodiment, the timing of periods 262 and 266 can be correlated to time stamps of video signal 110 to generate time-coded metadata that indicates the periods of high excitement of the user. The time-coded metadata can be stored in association with the video signal 110 as processed video signal 112. In this fashion, the excitement data 132 can be associated with the video content and can be used to search for and identify video content and/or particular portions of a recorded video corresponding to high levels of excitement of the user.

While the excitement data 132 is shown as a binary value, in other embodiments, excitement data 132 can be a multivalued signal that indicates a specific level of excitement of the user or others and/or a rate of increase in excitement of the user or others.

FIGS. 4 and 5 present pictorial diagram representations of components of a video system in accordance with embodiments of the present invention. In particular a pair of glasses/goggles 16 are presented that can be used to implement video system 100 or a component of video system 100.

The glasses/goggles 16 include biometric sensors in the form of perspiration and/or heart rate sensors incorporated in the nosepiece 254, bows 258 and/or earpieces 256 as shown in FIG. 4. In addition, one or more imaging sensors implemented in the frames 252 can be used to indicate eye wideness and pupil dilation of an eye of the wearer 250 as shown in FIG. 5.

In an embodiment, the glasses/goggles 16 further include a short-range wireless interface such as a Bluetooth or Zigbee radio that communicates biometric signals with a biometric signal processor and other components of video system, such as video system 100 described in conjunction with FIGS. 1 and 2, that are implemented in conjunction with a smartphone, video camera, digital camera, tablet, laptop or other device that is equipped with a complementary short-range wireless interface. In another embodiment, the glasses/goggles 16 further include a biometric signal processor and excitement data is transmitted via a short-range wireless interface such as a Bluetooth or Zigbee with other components of a video system that are implemented in conjunction with a smartphone, video camera, digital camera, tablet, laptop or other device that is equipped with a complementary short-range wireless interface. In yet another embodiment, the glasses/goggles 16 include a video capture device 120, such as in the frame 252 or nosepiece 254, a heads-up video display and the other elements so as to operate as a self-contained video system, such as video system 100 as previously described.

FIGS. 6-8 present pictorial diagram representations of video systems in accordance with embodiments of the present invention. In these embodiments, the smartphone 14 and video camera 10 include resistive or capacitive sensors in their cases that generate biometric signals 280 for monitoring heart rate and/or perspiration levels of the user as they grasp each device. Further the microphone in each device can be used a biometric sensor 280 as previously described in conjunction with FIG. 2.

In yet another embodiment, a Bluetooth headset 18 or other audio/video adjunct device that is pair or otherwise coupled to the smartphone 14 can include resistive or capacitive sensors in their cases that generate biometric signals 280 for monitoring heart rate and/or perspiration levels of the user. In addition, the microphone in the headset 18 can be used a biometric sensor 280 as previously described in conjunction with FIG. 2.

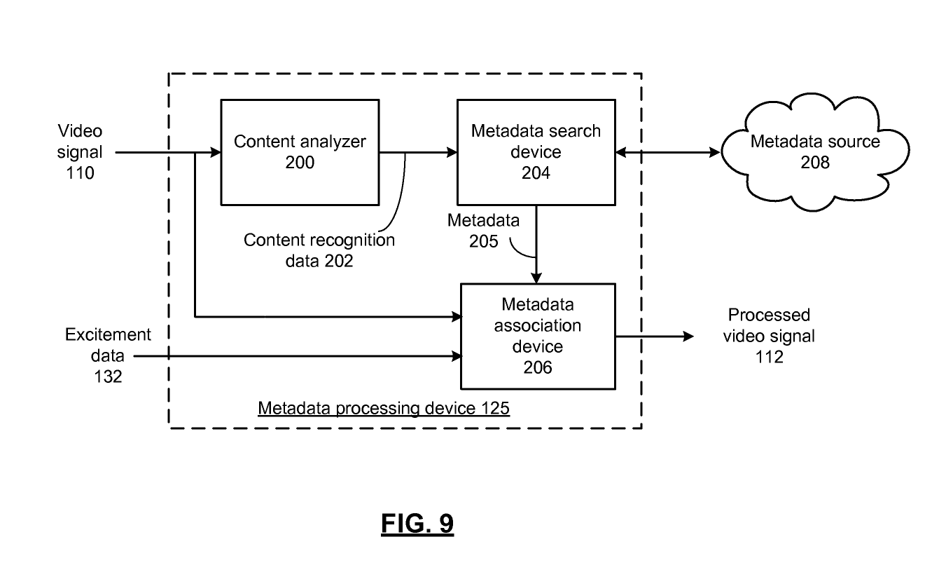

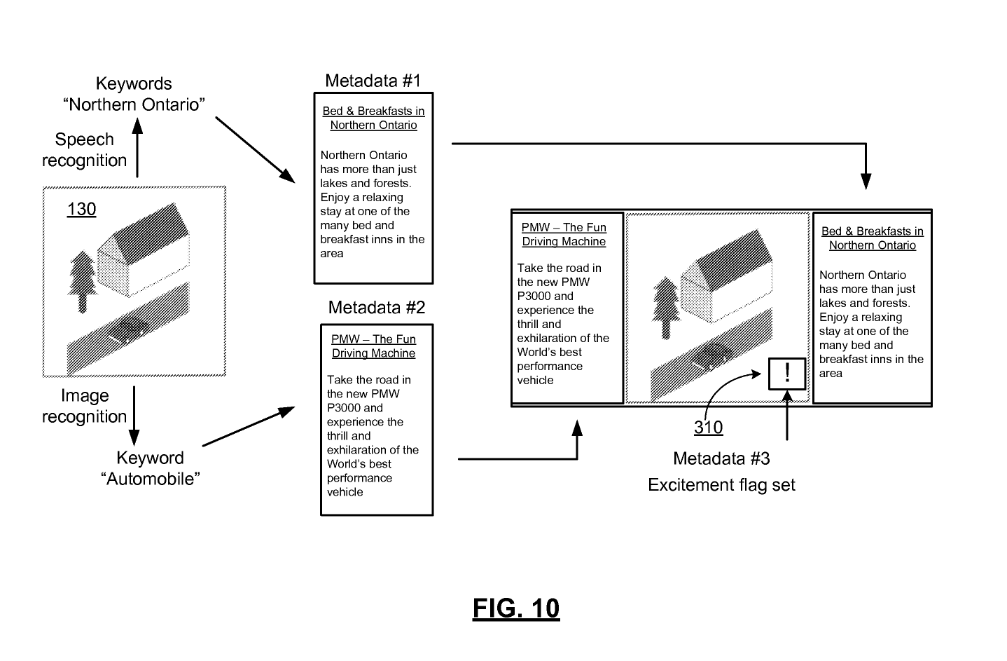

FIG. 9 presents a block diagram representation of a metadata processing device in accordance with an embodiment of the present invention. In this embodiment, in addition, to associating excitement data 132 with a video signal 110, other time-coded metadata is generated and associated with video signal 110 and incorporated in processed video signal 112. In particular, the generation of excitement data 132 can be combined with functions and features described in conjunction with the copending applications: VIDEO PROCESSING DEVICE FOR EMBEDDING TIME-CODED METADATA AND METHODS FOR USE THEREWITH, having application Ser. No. 13/297,471, filed on Nov. 16, 2011; VIDEO PROCESSING DEVICE FOR EMBEDDING AUTHORED METADATA AND METHODS FOR USE THEREWITH, having application Ser. No. 13/297,479, filed on Nov. 16, 2011; VIDEO DECODING DEVICE FOR EXTRACTING EMBEDDED METADATA AND METHODS FOR USE THEREWITH, having application Ser. No. 13/297,485, filed on Nov. 16, 2011; and VIDEO DECODING DEVICE FOR SELECTING EMBEDDED METADATA AND METHODS FOR USE THEREWITH, having application Ser. No. 13/297,489, filed on Nov. 16, 2011, the contents of which are incorporated herein by reference for any and all purposes.

In addition to the functions described in conjunction with FIGS. 1-8, metadata processing device 125 can mine alternative information sources for new information pertaining to a video signal 110. Such new information could be a link to new content or actual new content itself. For example, metadata processing device 125 can include a speech recognition module that generates a time-coded dialog text of the audio associated with the video signal 110 and perform Internet searches for historical quotes, images, background information and other potentially relevant information. Once new information/metadata is identified it can be filtered by relevance based on suitability criteria and inserted in a time-coded fashion to the original or transcoded content. This new content now contains original content but with relevant metadata that allows the end user, for example, to understand a video in new ways.

The metadata can be processed by the end user external to the video, but to be compatible with legacy products, the metadata can be watermarked and embedded in time-coded locations relevant to the content so that particular content can also be recompressed with new pictorial or audible data into a single stream that is viewable by such legacy devices as a single movie the way they understand them today. Multiple versions of content from original to heavily enhanced can be created and made available to user to choose which version to view. On more advanced viewing devices, the experience can be made to be more enhanced where metadata can be selectively rendered or viewed at user discretion on the final device. For example, family vacation pictures in New Zealand could be enhanced by additional metadata that discusses the region. Portions of high excitement during the trip can be specifically indicated by excitement data that is correlated to the corresponding portions of video.

In the embodiment shown, metadata processing device 125 includes a content analyzer 200, a metadata search device 204, and a metadata association device 206. In operation, content analyzer 200 receives a video signal 110 and generates content recognition data 202 based on the video signal 110. The content recognition data 202 is associated with at least one timestamp included in the video signal 110. Metadata search device 204 generates metadata 205 in response to the content recognition data 202 that is time-coded in accordance with the at least one time stamp of the video signal 110. Metadata association device 206 generates processed video signal 112 from either the video signal 110 or a transcoded version of video signal 110 generated by processing performed by metadata association device 206. In particular, the processed video signal 112 includes time-coded metadata with both metadata 205 and the excitement data 132 along with the original or transcoded video signal 110.

The content analyzer 200, metadata search device 204, and metadata association device 206 can each be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory. These memories may each be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when content analyzer 200, metadata search device 204 and metadata association device 206 implement one or more of their functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

Content analyzer 200 operates to generate content recognition data 202 in a form or format that can be used by metadata search device 204 to search one or more metadata sources 208 for metadata 205 to be embedded in the video. In particular, the content analyzer 200 identifies content that occurs at certain points in the video signal 110 based on time stamps included in the video so that metadata associated with that content can be synchronized with the video for search and/or presentation to the user.

In an embodiment of the present invention, the content analyzer 200 includes a pattern recognition module that uses speech recognition and or image recognition to generate the content recognition data 202 based on a recognition of speech in audio information included in the video signal 110 and/or based on image recognition of the particular images included in the video signal 110. Consider an example where a segment of video at a particular time stamp or range of time stamps shows an automobile driving along a country road. The audio portion of the video discusses the beauty of the Northern Ontario at that time of the year. The pattern recognition module of content analyzer 200 analyzes the images included in this video segment and recognizes a particular object, an automobile. In addition, the pattern recognition module of content analyzer 200 analyzes the audio included in this video segment and recognizes a particular place, Northern Ontario. In response, the content analyzer 200 generates content recognition data 202 that indicates the keywords, “automobile” and “Northern Ontario” associated with the timestamp or range of time stamps that are associated with this particular portion of video signal 110.

While the content analyzer 200 is described above in speech and image recognition, other portions of video signal 110 can be used to generate metadata associated with the video content. In particular, content analyzer 200 can identify content recognition data 202 such as key words or other indicators based on closed captioning text included in the video signal 110, character recognition of images in the video signal 110 and via other identification or recognition routines.

Metadata search device 204 is coupled to one or more metadata sources 208 such as local storage, a local area network or a wide area network such as the Internet. In an embodiment of the present invention, the metadata search device 204 includes a search engine that searches the metadata source or sources along with a content evaluator that evaluates the relevancy of content that was located to identify metadata 205 for inclusion in the processed video signal 112, based on the content recognition data 202. In this fashion, content relating to persons, places, objections, quotes, movies, songs, events, or other items of interest can be identified for inclusion as metadata 205 in processed video 112.

Consider the example discussed above, where a segment of video at a particular time stamp or range of time stamps shows an automobile driving along a country road. The key words “automobile” and “Northern Ontario” indicated by content recognition data 202 are input to a search engine that, for example, locates web content associated with these keywords. The web content is evaluated for relevancy based on, for example its age, image quality, website reviews or other rankings, or other evaluation criteria to determine the particular metadata 205 to be generated. When the metadata search device 204 generates a plurality of search results, it also generates associated relevance data and selects the time-coded metadata 205 based on an analysis of this relevance data. For example, the metadata search device 204 can select the time-coded metadata 205 by comparing the associated relevance data to a relevance threshold, by selecting content with the highest relevance, or by other analysis of the relevance data or other data associated with the identified content, such as media format, file size, etc.

In an embodiment of the present invention, the metadata 205 includes the particular content, the text data, image data, video data and/or audio data or other media data identified by metadata search device 204. In an alternative embodiment, metadata 205 includes links to some or all of the identified content in the form of a file address, network address such as a Universal Resource Locator (URL) or other locator, rather than including all of the identified content itself. If the particular, video segment generates a high level of excitement, such as when the user records a view of a house where he once lived as a child or an exciting new car that passes by, excitement data 132 indicating a high level of excitement can be included with metadata 205 and included as time-coded metadata in the processed video signal 112.

The metadata association device 206 generates the processed video signal 112 by combining the time-coded metadata with the video signal at time-coded locations in accordance with the at least one time stamp. This can be accomplished in several ways.

In one mode of operation where the metadata 205 includes media content, the processed video signal 112 can be presented as a standard video signal where metadata in the form of text, images, video are combined with the video signal 110 or the transcoded video signal 110 in a fashion to be presented in a picture-in-picture, split screen or overlaid on the original video.

For example, the original video programming from video signal 110 can be present in a letterbox or pillar box format with the normally unused letterbox or pillar box areas filled in with media from metadata 205. Likewise, in a picture-in-picture or split screen mode of operation the media content from metadata 205 can be presented in a separate portion of the screen from the video programming from video signal 110. In another example where the metadata is primarily text or simple images, the metadata 205 can be overlaid on the video programming from video signal 110. In each of these examples, the processed video signal 112 can be formatted for decoding and/or direct display on a legacy video device such as a set top box, wireless telephone, personal video player, standard television, monitor or other video display device.

As discussed above, the metadata 205 time-coded based on the time stamps associated with the content recognition data 202. Metadata 205 can include similar time stamps, or ranges of time stamps or other time coding data that are used to align and synchronize the presentation of the metadata 205 with the corresponding portions of the video signal 110. In this fashion, portions of the original video, corresponding to the time stamp or range of time stamps that yielded the content recognition data 202, are presented contemporaneously with the metadata 205 identified by metadata search device 204 in response to that particular content recognition data 206. In the mode of operation discussed above where the metadata 205 is directly combined with the video programming from video signal 110, the metadata association module 206 uses the time-coding of metadata 205 to align and synchronize the presentation of the metadata 205 with the corresponding portions of the video signal 110.

In another mode of operation, the metadata association device 206 generates the processed video signal 112 by embedding the time-coded metadata 205 as a watermark on the video signal. In this fashion, the time-coded metadata 205 in the form of media or media links can be watermarked and embedded in time-coded locations relevant to the content so that the video program can also be re-encoded into a single stream. The original video content can be decoded and viewed by legacy devices—however, the watermarking can be extracted and processed to extract either the additional media content or links to additional content that can be viewed with enhanced viewing devices or additional display devices.

It should be noted that other techniques can be used by the metadata association device 206 to combine the content from video signal 110 into the processed video signal 112. In another mode of operation, the content of video signal 110 in the form of video packets can be encapsulated into another protocol that carries the metadata 205. The metadata 205 and video signal 110 can be extracted by a decoding device by unwrapping the outer protocol and passing the video packets to a video coder for separate decoding. Other techniques include interspersing or interleaving the metadata 205 with the video content from video signal 110, transmitting the metadata 205 in a separate layer such as an enhanced layer of an MVC formatted or other multi-layer formatted video, or transmitting the metadata 205 concurrently with the video content of video signal 110 via other time division multiplexing, frequency division multiplexing, code division multiplexing or other multiplexing technique.

It should also be noted that processed video signal 112 can be presented in a variety of other formats. A multiplexed audio/video (AV) signal with digital metadata 205 can be combined in each data packet where the audio, video and metadata are separated digitally. The metadata 205 can be rendered and mixed with the audio or mixed with the video or both and then re-encoded digitally so the metadata is not separable from the audio or video or both. The AV and metadata can be formatted as separate signals sent out in parallel as distinct signals over distinct paths or the same path. Also, the AV can be sent contiguously while metadata 205 are kept in the metadata processing device 125 (within a local database) for retrieval on demand as required by the final viewing device.

FIG. 10 presents a pictorial process flow representation in accordance with an embodiment of the present invention. In particular, an example process flow is shown in conjunction with one particular mode of operation of metadata processing device 125.

In the example shown, a segment 130 of video 110 at a particular time stamp shows an automobile driving along a country road. The audio portion of the video discusses the beauty of the Northern Ontario at that time of the year. The pattern recognition module of content analyzer 200 analyzes the images included in this video segment and recognizes a particular object, an automobile. In addition, the pattern recognition module of content analyzer 200 analyzes the audio included in this video segment and recognizes a particular place, “Northern Ontario”. In response, the content analyzer 200 generates content recognition data 202 that indicates the keywords, “automobile” and “Northern Ontario” associated with the timestamp or range of time stamps that are associated with this particular segment 130.

The key words “automobile” and “Northern Ontario” indicated by content recognition data 202 are input via metadata search device 204 to a search engine that, for example, locates web content associated with these keywords. The web content is evaluated for relevancy based on, for example its age, image quality, website reviews or other rankings, or other suitability criteria to determine the particular metadata 205 to be generated. When the metadata search device 204 generates a plurality of search results, it also generates associated relevance data and selects the time-coded metadata 205 based on an analysis of this relevance data. In the example shown, Metadata #1 is a portion of hypertext generated in response to the keywords “Northern Ontario” that discusses bed and breakfast inns. Metadata #2 is a portion of hypertext generated in response to the keyword “automobile” that includes an advertisement for a particular model of automobile, the P3000. Metadata #3 includes the excitement data indicating a high level of excitement.

As shown in a rendering of the processed video signal 112, segment 130 of video 110 is presented in a pillar box format with the pillar box areas filled in with media from metadata#1 and metadata#2 and an icon 310 is overlaid on the video screen indicating that a high level of excitement was present when the user recorded the video. As discussed in conjunction with FIG. 2, in this mode of operation the processed video signal 112 is formatted for decoding and/or direct display on a legacy video device such as a set top box, wireless telephone, personal video player, standard television, monitor or other video display device.

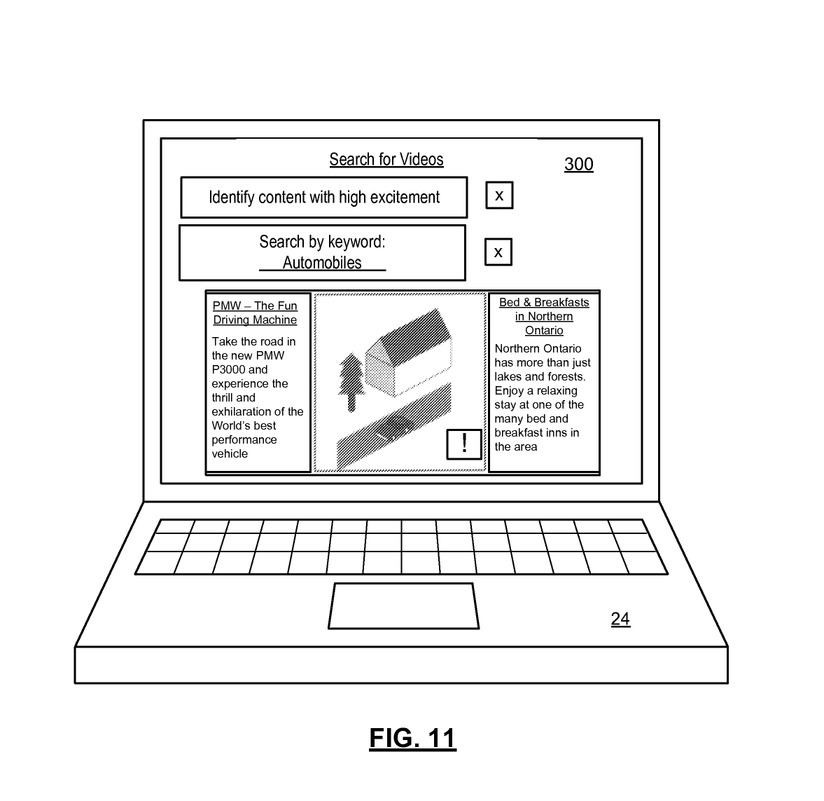

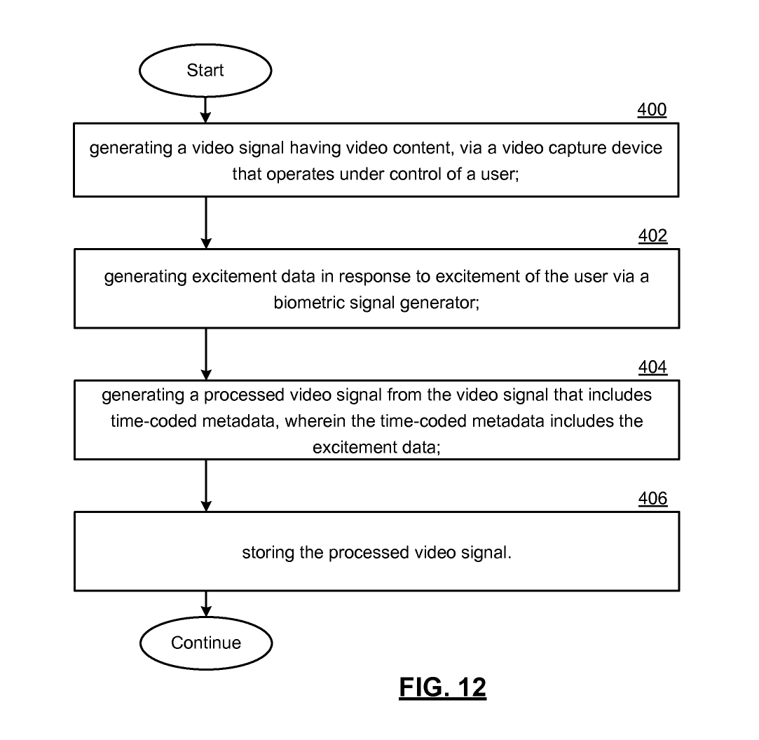

FIG. 11 presents a pictorial diagram representation of a video processing device in accordance with an embodiment of the present invention. In particular, an embodiment of video system 100 is presented that includes a laptop computer that implements video storage device 140 via a hard disk or other drive or memory, video player 150 via a software module or hardware and a user interface that includes a display screen, pointing device and keyboard. In the embodiment shown, the video player operates in conjunction with the laptop computer 24 to present a graphical user interface that allows a user to search for video content stored on the laptop computer.

A screen display 300 is presented that allows a user to search for time-coded metadata having, for example, a matching keyword and a high level of excitement. In this fashion, the user of laptop 24 is able to identify, retrieve and playback particular processed video signals that are associated with high levels of user excitement and further to specifically locate the periods of time in the processed video signal corresponding to the periods of high excitement of the user. For example, the video storage device can queue up a processed video signal at a period of time corresponding to a period of high excitement of the user. As previously discussed, this avoids having the user having to manually hunt through different videos to locate a video of interest and/or having the user hunting through a video for particular portions associated with an exciting event or occurrence.

FIG. 12 presents a flow diagram representation of a method in accordance with an embodiment of the present invention. In particular, a method is presented for use with one or more of the function and features described in conjunction with FIGS. 1-11. Step 400 includes generating a video signal having video content, via a video capture device that operates under control of a user. Step 402 includes generating excitement data in response to excitement of the user via a biometric signal generator. Step 404 includes generating a processed video signal from the video signal that includes time-coded metadata, wherein the time-coded metadata includes the excitement data. Step 406 includes storing the processed video signal.

In an embodiment, the time-coded metadata indicates periods of high excitement of the user. In particular, the time-coded metadata can correlate the periods of high excitement of the user to corresponding periods of time in the video signal. Step 404 can include generating at least one biometric signal based on the user, and also generating the excitement data based on analysis of the at least one biometric signal. The at least one biometric signal can indicate at least one of: a dilation of an eye of the user, a wideness of opening of an eye of the user, a heart rate of the user, or a level of perspiration of the user.

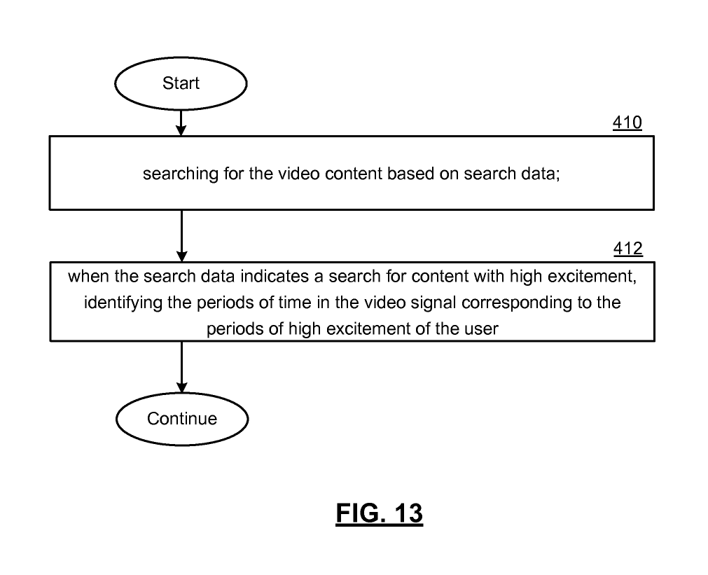

FIG. 13 presents a flow diagram representation of a method in accordance with an embodiment of the present invention. In particular, a method is presented for use with one or more of the function and features described in conjunction with FIGS. 1-12. Step 410 includes searching for the video content based on search data. When the search data indicates a search for content with high excitement, the method identifies the periods of time in the video signal corresponding to the periods of high excitement of the user as shown in step 412.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path.

While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A video system comprising:
a video capture device that operates under control of a user to generate a video signal having video content;
a biometric signal generator that generates excitement data in response to excitement of the user;
a metadata association device, coupled to the video capture device and the biometric signal generator, that generates a processed video signal from the video signal that includes time-coded metadata, wherein the time-coded metadata includes the excitement data; and
a video storage device, coupled to the metadata association device, that stores the processed video signal.

2. The video system device of claim 1 wherein the time-coded metadata indicates periods of high excitement of the user.

3. The video system device of claim 2 wherein the time-coded metadata correlates the periods of high excitement of the user to corresponding periods of time in the video signal.

4. The video system device of claim 3 further comprising:
a video player, coupled to the video storage device, that searches for the video content based on search data, and when the search data indicates a search for content with high excitement, that identifies the periods of time in the video signal corresponding to the periods of high excitement of the user.

5. The video system device of claim 1 wherein the biometric signal generator includes:
at least one biometric sensor that generates at least one biometric signal based on the user; and
a biometric signal processor that generates the excitement data based on analysis of the at least one biometric signals.

6. The video system device of claim 5 wherein the at least one biometric sensor includes an imaging sensor and wherein the at least one biometric signal indicates at least one of: a dilation of an eye of the user, or a wideness of opening of an eye of the user.

7. The video system device of claim 5 wherein the at least one biometric signal indicates at least one of: a heart rate of the user, or a level of perspiration of the user.

8. A method comprising:
generating a video signal having video content, via a video capture device that operates under control of a user;
generating excitement data in response to excitement of the user via a biometric signal generator;
generating a processed video signal from the video signal that includes time-coded metadata, wherein the time-coded metadata includes the excitement data; and
storing the processed video signal.

9. The method of claim 8 wherein the time-coded metadata indicates periods of high excitement of the user.

10. The method of claim 9 wherein the time-coded metadata correlates the periods of high excitement of the user to corresponding periods of time in the video signal.

11. The method of claim 10 further comprising:
searching for the video content based on search data; and
when the search data indicates a search for content with high excitement, identifying the periods of time in the video signal corresponding to the periods of high excitement of the user.

12. The method of claim 8 wherein generating the excitement data includes:
generating at least one biometric signal based on the user; and
generating the excitement data based on analysis of the at least one biometric signal.

13. The method of claim 12 wherein the at least one biometric signal indicates at least one of: a dilation of an eye of the user, or a wideness of opening of an eye of the user.

14. The method of claim 12 wherein the at least one biometric signal indicates at least one of: a heart rate of the user, or a level of perspiration of the user.
